(19) United States
(12) Patent Application Publication
(10) Pub. No.: US 2020/0087002 A1
(43) Pub. Date: Mar. 19, 2020

(54) VIBRATORY WEIGHT-ON-WHEELS SENSING

(71) Applicant: Sikorsky Aircraft Corporation, Stratford, CT (US)

(72) Inventors: Bradley M. Bauer, Jr., Middletown, CT (US); William A. Welsh, North Haven, CT (US)

(21) Appl. No.: 15/746,958

(22) PCT Filed: Jun. 22, 2016
(86) PCT No.: PCT/US16/38732

§ 371 Date: Jan. 23, 2018

Related U.S. Application Data
(60) Provisional application No. 62/209,088, filed on Aug. 24, 2015.

(51) Int. Cl. B64D 45/00; G01M 17/013

(52) U.S. Cl. CPC B64D 45/00; G01P 15/00; G01M 17/013

(57) ABSTRACT

A vibratory weight-on-wheels (WOW) sensing system is provided for use with aircraft landing gear and a wheel coupled to the aircraft landing gear. The WOW sensing system includes a vibration sensor disposed proximate to the wheel and configured to sense vibratory characteristics of a component of the aircraft landing gear and to issue a sensing reflective signal and a processing unit disposed in signal communication with the vibration sensor such that the processing unit is receptive of the sensing reflective signal. The processing unit is configured to analyze the sensing reflective signal to thereby identify that a landing condition is in effect.

### FEDERAL RESEARCH STATEMENT

This invention was made with government support under Contract No.: HR-0011-15-9-0004. The government therefore has certain rights in this invention.

### BACKGROUND OF THE DISCLOSURE

The subject matter disclosed herein relates to weight-on-wheel sensing and, more particularly, to vibratory weight-on-wheels sensing for use with aircraft landing gear.

Traditionally, weight-on-wheels (WOW) for an aircraft has been detected using mechanical switches, radially variable differential transformers (RVDT) or linearly variable differential transformers (LVDT). In these cases, the traditional sensing hardware mechanically derives the position of some component in the landing gear system that moves when the aircraft lands (typically shock strut or drag beam movement) and thus senses a landing in response to such movement. These mechanical methods have limitations, however, in that they rely on the proper operation of the landing gear.

For example, for a BLACK HAWK helicopter, a mechanical switch senses the movement of a shock strut when the helicopter lands. Thus, if this shock strut is not properly serviced or has a leak, the WOW indication from the mechanical switch will tend to be erroneous or will not behave as expected.

### BRIEF DESCRIPTION OF THE DISCLOSURE

According to one aspect of the disclosure, a vibratory weight-on-wheels (WOW) sensing system is provided for use with aircraft landing gear and a wheel coupled to the aircraft landing gear. The WOW sensing system includes a vibration sensor disposed proximate to the wheel and configured to sense vibratory characteristics of a component of the aircraft landing gear and to issue a sensing reflective signal and a processing unit disposed in signal communication with the vibration sensor such that the processing unit is receptive of the sensing reflective signal. The processing unit is configured to analyze the sensing reflective signal to thereby identify that a landing condition is in effect.

In accordance with additional or alternative embodiments, the vibration sensor is disposed on a drag beam of the aircraft landing gear.

In accordance with additional or alternative embodiments, the vibration sensor includes an accelerometer.

In accordance with additional or alternative embodiments, the processing unit includes a digital band pass filter.

In accordance with additional or alternative embodiments, the processing unit is configured to identify that a landing condition is in effect from changes in amplitude of the sensing reflective signal.

In accordance with additional or alternative embodiments, the processing unit is configured to generate a characteristic in-flight vibratory signature of the aircraft landing gear.

In accordance with additional or alternative embodiments, the processing unit is configured to issue a warning in an event an analysis of the sensing reflective signal gives a different indication than mechanical WOW sensors.

According to yet another aspect of the disclosure, a vibratory weight-on-wheels (WOW) sensing system is provided for use with aircraft landing gear and a wheel coupled to the aircraft landing gear. The WOW sensing system includes an actuator configured to vibrate a component of the aircraft landing gear at a predefined frequency and amplitude, a vibration sensor disposed proximate to the wheel and configured to sense vibratory characteristics of the component and to issue a sensing reflective signal and a processing unit disposed in signal communication with the vibration sensor such that the processing unit is receptive of the sensing reflective signal. The processing unit is configured to analyze the sensing reflective signal to thereby identify that a landing condition is in effect.

In accordance with additional or alternative embodiments, the actuator and the vibration sensor are both disposed on a drag beam of the aircraft landing gear at a distance from each other.

In accordance with additional or alternative embodiments, the actuator and the vibration sensor are co-located on a drag beam of the aircraft landing gear.

In accordance with additional or alternative embodiments, the vibration sensor includes an accelerometer.

In accordance with additional or alternative embodiments, the processing unit includes a digital band pass filter.

In accordance with additional or alternative embodiments, the processing unit is configured to identify that a landing condition is in effect from changes in amplitude of the sensing reflective signal.

In accordance with additional or alternative embodiments, the processing unit is configured to generate a characteristic in-flight vibratory signature of the aircraft landing gear.

In accordance with additional or alternative embodiments, the processing unit is configured to issue a warning in an event an analysis of the sensing reflective signal gives a different indication than mechanical WOW sensors.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an aircraft and aircraft landing gear in accordance with embodiments;

FIG. 2 is an exploded perspective view of aircraft landing gear in accordance with embodiments;

FIG. 3 is a cross-sectional view of an actuator of the aircraft landing gear of FIG. 2;

FIG. 4 is a cross-sectional view of a vibration sensor of the aircraft landing gear of FIG. 2;

FIG. 5 is a schematic illustration of a co-located actuator and vibration sensor in accordance with embodiments

FIG. 6 is a cross-sectional view of an actuator of the aircraft landing gear of FIG. 2;

FIG. 7 is a cross-sectional view of a vibration sensor of the aircraft landing gear of FIG. 2;

FIG. 8 is a schematic illustration of a co-located actuator and vibration sensor in accordance with embodiments;

FIG. 9 is a schematic diagram of a processing unit in accordance with embodiments; and

FIG. 10 is a graphical display of amplitude versus frequency of aircraft landing gear.

The detailed description explains embodiments of the disclosure, together with advantages and features, by way of example with reference to the drawings.

### DETAILED DESCRIPTION OF THE DISCLOSURE

As will be described below, a vibration based weight-on-wheels (WOW) sensing system is provided that does not rely on mechanical functions of the landing gear and thus will give a more robust and reliable WOW indication. Vibratory WOW sensing uses a vibration sensor mounted on the landing gear to detect changes in the amplitude of frequencies chosen to be monitored. The frequencies to be monitored are chosen by determining where the frequency spectrum response of the landing gear, in the air and on the ground, is pronouncedly different. An actuator then produces a vibration at that frequency to excite the landing gear for the sensor to pick up. Software will then determine if there is WOW based on changes in vibratory amplitudes over time due to resonant frequencies of the landing gear shifting when the landing gear makes contact with the ground and the tire dampens vibrations.

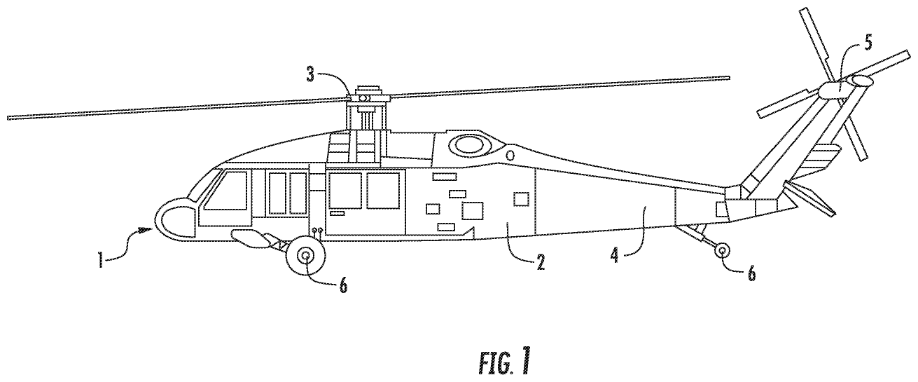

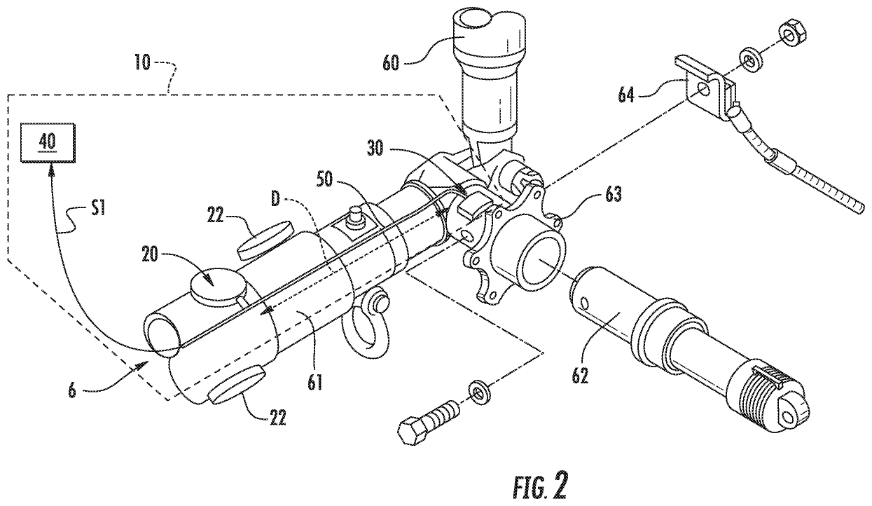

With reference to FIGS. 1 and 2, an aircraft 1 is provided and may be configured as a helicopter. The aircraft 1 includes an airframe 2, which is formed to define a cockpit that can accommodate a pilot and one or more crewmembers and/or passengers as well as an engine and a flight computer. The aircraft 1 further includes a main rotor 3, which is disposed at an upper portion of the airframe 2, a tail 4 that extends aft from the airframe 2 and a tail rotor 5, which is disposed at a distal end of the tail 4. The main rotor 3 and the tail rotor 5 are both drivable by the engine and a transmission system to rotate about respective rotational axes and to thereby generate lift, thrust and yaw control for the aircraft 1. In addition, the aircraft 1 includes landing gear 6 at a lower portion of the airframe 2.

As shown in FIG. 2, the landing gear 6 includes a vertically oriented shock strut 60, a horizontally oriented drag beam 61, which is attached to the airframe 2, a horizontally oriented axle 62, a brake mounting flange 63, a wheel (not shown) and a static discharge wick/wire 64. The drag beam 61 and the axle 62 are both transversely oriented relative to one another and to the shock strut 60 and connected to the shock strut 60 at respective ends thereof. The brake mounting flange 63 is disposed about the axle 62 proximate to the connection between the shock strut 60, the drag beam 61 and the axle 62. The wheel is coupled with the brake mounting flange 63 to be rotatable about the axle 62. The static discharge wick/wire 64 is attachable to the landing gear 6 proximal to the wheel.

With the above-described configuration, the aircraft 1 is operable for in-flight operations, grounded operations or transitional operations. In-flight operations may be characterized as situations in which the wheel(s) of the landing gear 6 is/are not in contact with a ground surface (e.g., horizontal flight or hover). Grounded operations, by contrast, may be characterized as situations in which the wheel(s) of the landing gear 6 is/are in touch with the ground surface and the shock strut(s) 60 is/are supportive of an entire weight of the aircraft 1 (e.g., prior to take-off and following a landing). The transitional operations may be characterized as situations in which the wheel(s) of the landing gear 6 is/are in touch with the ground surface but the shock strut(s) 60 is/are only partially supporting the aircraft 1 weight (e.g., during take-off and landing transitions). As such, the aircraft 1 may be equipped with one or more systems for detecting when the aircraft 1 is conducting in-flight operations, grounded operations or transition operations.

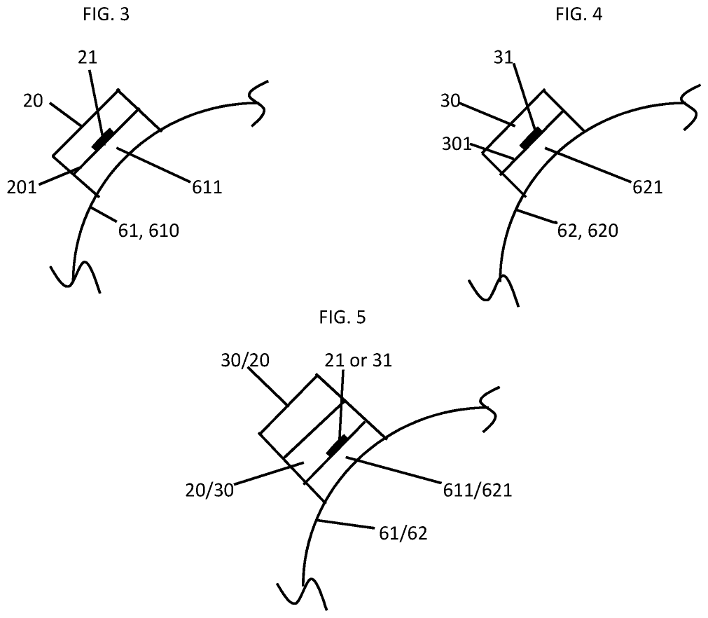

With continued reference to FIG. 2 and with additional reference to FIGS. 3-7, a vibratory weight-on-wheels (WOW) sensing system 10 is provided for use with the aircraft 1 and, more particularly, with the landing gear 6. The WOW sensing system 10 includes an actuator 20, a vibration sensor 30 and a processing unit 40.

The actuator 20 is configured to excite or otherwise vibrate (hereinafter referred to as vibrate) one or more components of the landing gear 6 at a predefined frequency and amplitude. These one or more components can be any of the various components described above or other similar components but may, in some embodiments, be the drag beam 61 and/or the axle 62.

The vibration sensor 30 is disposed proximate to the wheel and is configured to sense vibratory characteristics of the component (i.e., the drag beam 61 or the axle 62) and to issue a sensing reflective signal S1 accordingly based on a result of the sensing.

The processing unit 40 may be a component of the flight computer or a stand-alone computing device and is disposed in signal communication with the vibration sensor 30 to be receptive of the sensing reflective signal S1. The processing unit 40 is further configured to analyze the sensing reflective signal S1 and to identify from a result of the analysis that a landing condition is in effect and that the aircraft 1 is conducting the grounded or transition operations.

For purposes of clarity and brevity, the embodiments in which the actuator 20 and the vibration sensor 30 are disposed on one or both of the drag beam 61 and the axle 62 will be described below. Such description is exemplary, however, and it will be understood that alternative configurations are possible.

The WOW sensing system 10 may further include a wiring system 50 and a power source. The wiring system 50 is coupled to the actuator 20, the vibration sensor 30 and the processing unit 40 and thus provides for power transfer from the power source to the various components of the WOW sensing system 10. The wiring system 50 also provides for control of the actuator 20 and the vibration sensor 30 by the processing unit 40 and for transmission of control signals from the processing unit 40 to the actuator 20 and the vibration sensor 30 as well as transmission of the sensing reflective signal S1 from the vibration sensor 30 to the processing unit 40. At least one or more components of the wiring system 50 may be provided by way of wired or wireless communication elements.

In accordance with embodiments, where the actuator 20 and the vibration sensor 30 are disposed on the drag beam 61 and the axle 62, respectively, for example as shown in FIGS. 2-4, the actuator 20 may be separated from the vibration sensor 30 by a predefined distance D. This predefined distance D is long enough to reduce a tendency of the vibration sensor 30 to pick up movements of the actuator 20 instead of vibrations of the drag beam 61 that are caused by the actuator 20 and yet is short enough to insure that the vibrations of the drag beam 61 and the axle 62, which are caused by the actuator 20, are strong enough to be reliably sensed by the vibration sensor 30.

In this or any other case, as shown in FIGS. 3-5, the drag beam 61 and the axle 62 may have a respective curved surface 610 and 620 and a respective boss 611 and 621 on which the actuator 20 and the vibration sensor 30 are respectively disposed. In such cases, the actuator 20 and the vibration sensor 30 may each have a respective contact surface 201, 301 that abut with the exterior surfaces of the respective bosses 611 and 621 of the drag beam 61 and the axle 62, respectively.

That is, as shown in FIG. 3, the contact surface 201 of the actuator 20 may be flexible and acted upon by a movable actuating element 21 such that, upon activation of the actuator 20, the actuating element 21 moves and thus causes the contact surface 201 to correspondingly move back and forth to vibrate the drag beam 61 (directly) and the axle 62 (indirectly) by way of the intervening boss 611. In this way, a substantial area of contact may be formed between the contact surface 201 of the actuator 20, the boss 611 and the curved surface 610 of the drag beam 61 such that actuations of the actuating element 21 of the actuator 20 may be reliably transmitted to the drag beam 61 as vibrations. Similarly, as shown in FIG. 4, the contact surface 301 of the vibration sensor 30 may include a sensing element 31, such as an accelerometer. In this way, a substantial area of contact may be formed between the contact surface 301 of the vibration sensor 30, the boss 621 and the curved surface 620 of the drag beam 61 such that vibrations of the drag beam 61 and the axle 62 can be reliably sensed by the sensing element 31 of the vibration sensor 30.

In accordance with alternative embodiments and, as shown in FIG. 5, the actuator 20 and the vibration sensor 30 may be co-located on, for example, the respective boss 611 or 621 of the drag beam 61 or the axle 62. In these or other similar cases, the actuator 20 and the vibration sensor 30 may be disposed side-by-side or on top of one another. In either case, the relative positioning of the actuator 20 and the vibration sensor 30 can be interchangeable.

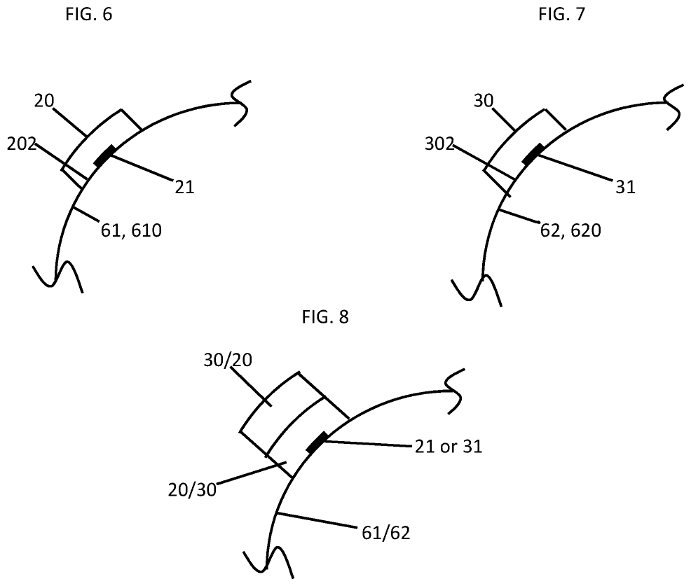

In accordance with further examples and embodiments, as shown in FIGS. 6-8, the actuator 20 and the vibration sensor 30 may be disposed directly on the respective curved surfaces 610 and 620 of the drag beam 61 and the axle 62. In such cases, the actuator 20 and the vibration sensor 30 may each have a respective complementarily curved contact surface 202, 302 that abut with the curved surfaces 610 and 620 of the drag beam 61 and the axle 62, respectively.

That is, as shown in FIG. 6, the curved contact surface 202 of the actuator 20 may be flexible and acted upon by the movable actuating element 21 such that, upon activation of the actuator 20, the actuating element 21 moves and thus causes the curved contact surface 202 to correspondingly move back and forth to vibrate the drag beam 61 (directly) and the axle 62 (indirectly). In this way, a substantial area of contact may be formed between the curved contact surface 202 of the actuator 20 and the curved surface 610 of the drag beam 61 such that actuations of the actuating element 21 of the actuator 20 may be reliably transmitted to the drag beam 61 as vibrations. Similarly, as shown in FIG. 7, the curved contact surface 302 of the vibration sensor 30 may include a sensing element 31, such as an accelerometer. In this way, a substantial area of contact may be formed between the curved contact surface 302 of the vibration sensor 30 and the curved surface 620 of the axle 62 such that vibrations of the drag beam 61 and the axle 62 can be reliably sensed by the sensing element 31 of the vibration sensor 30.

In accordance with alternative embodiments and, as shown in FIG. 8, the actuator 20 and the vibration sensor 30 may be co-located on, for example, the drag beam 61 or the axle 62. In these or other similar cases, the actuator 20 and the vibration sensor 30 may be disposed side-by-side or on top of one another. In either case, the relative positioning of the actuator 20 and the vibration sensor 30 can be interchangeable.

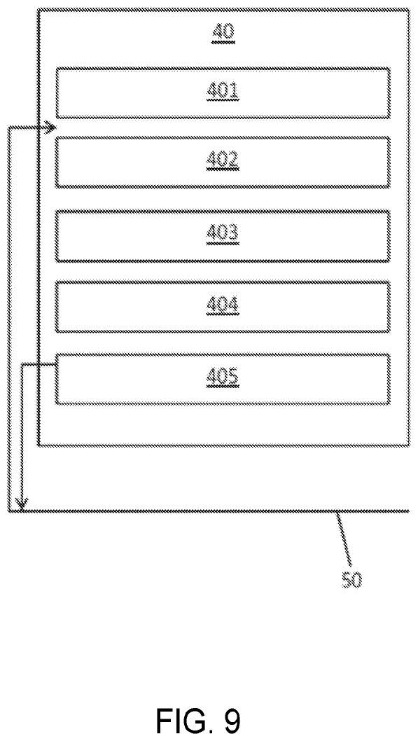

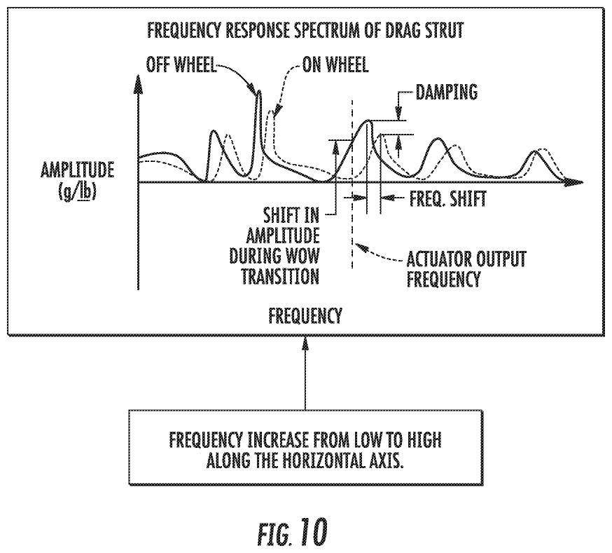

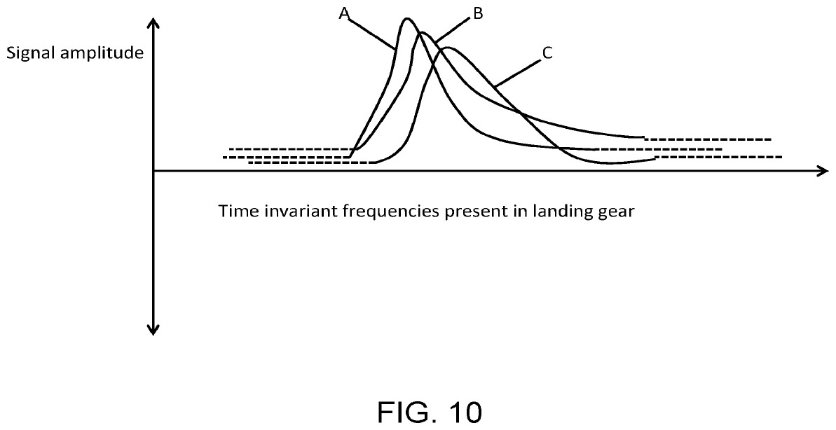

As shown in FIGS. 9 and 10, the processing unit 40 may include a networking unit 401 by which the processing unit 40 communicates with the other components of the WOW sensing system 10, a main processing unit 402 and a memory unit 403. The memory unit 403 has executable instructions stored thereon, which, when executed cause the main processing unit 402 to execute the method and algorithms described herein. In accordance with embodiments, the processing unit 40 may further include a filtering unit 404 coupled to at least one or both of the networking unit 401 and the main processing unit 402 as well as a servo command unit 405. The filtering unit may be provided as a digital band pass filter, for example. The servo command unit 405 is controllable by the main processing unit 402 to issue servo commands to the actuator 20 that in turn cause the actuator 20 to activate and excite or vibrate the drag beam 61.

During an operation of the WOW sensing system 10, whether the aircraft 1 is executing in-flight operations, grounded operations or transition operations, executions of the executable instructions stored on the memory unit 403 cause the main processing unit 402 to instruct the servo command unit 405 to cause the actuator 20 to activate and vibrate the drag beam 61 at a known frequency and amplitude. The resultant vibrations of the drag beam 61 and the axle 62 are sensed by the vibration sensor 30, which issues the sensing reflective signal S1 to be received by the processing unit 40. Within the processing unit 40, the sensing reflective signal S1 is acted upon by the filtering unit 404 to permit only the vibrations of a certain frequency (e.g., the frequency and amplitude of the actuator 20 and the corresponding frequency and amplitude of the drag beam 61 and the axle 62) to be analyzed such that vibrations of the aircraft 1 besides those generated by the actuator 20 do not disturb the analysis.

A graphical display of a particular frequency and amplitude of the various vibrations of the drag beam 61 and the axle 62 during in-flight operations (plot A), transition operations (plot B) and grounded operations (plot C), which are each derivable from the received sensing reflective signal S1, is shown in FIG. 10. Thus, FIG. 10, which is not time variant, illustrates that the particular frequency and amplitude of the vibrations of the drag beam 61 and the axle 62 generally follow those of the sensing reflective signal S1 and that, as the aircraft 1 lands by executing sequential in-flight, transition and grounded operations and takes off by executing the reverse process, the amplitudes and the frequencies of the vibrations change. These changes are due to the resonant frequencies of the landing gear 6 shifting.

For example, plot A of FIG. 10 relates to in-flight operations and thus exhibits relatively high signal amplitude since the landing gear 6 bears no weight and the vibrations of the drag beam 61 and the axle 62 are not damped. By contrast, plot B relates to transition operations and thus exhibits reduced signal amplitude as compared to plot A since the landing gear 6 begins to absorb some aircraft weight and the vibrations of the drag beam 61 and the axle 62 become increasingly damped. Finally, plot C relates to grounded operations and thus exhibits fully reduced signal amplitude as compared to plot B since the landing gear 6 bears the entire aircraft weight and the vibrations of the drag beam 61 and the axle 62 become fully damped.

In accordance with embodiments, the change in signal amplitude from plot A to plot B and from plot B to plot C is indicative of a landing of the aircraft 1. The main processing unit 402 is configured to identify such indication and, in particular, to issue a WOW alert to the flight control computer of the aircraft 1 or to issue a warning to the operator and the flight control computer in case the indication is not identified by other on-board WOW sensing systems. In accordance with further embodiments, the main processing unit 402 may be configured to generate and ascertain a characteristic in-flight vibratory signature of the landing gear 6 with the sensing reflective signal S1 being changeable and only temporarily associated with the in-flight vibratory signature of the landing gear 6 for a given mission.

With reference back to FIG. 2 and, in accordance with further embodiments, the actuator 20 may be paired with secondary actuators 22. In the exemplary case in which the actuator 20 is disposed on the drag beam 61, the secondary actuators 22 may be disposed on the drag beam 61 proximate to the actuator 20. The processing unit 40 then controls the secondary actuators 22 to vibrate the drag beam 61 in a manner to cancel out the vibrations of the aircraft 1. As such, a reliability of the sensing by the vibrations sensor 30 may be improved and, in some cases, a need for the filtering unit 404 may be decreased.

In accordance with alternative embodiments, the WOW sensing system 10 may be operable even with the actuator 20 being discarded or deactivated. In such cases, the natural resonant frequencies and amplitudes of normal vibrations of the aircraft 1 can be reliably sensed by the vibration sensor 30 during in-flight and transition conditions and with the main rotor 3 and the tail rotor 5 rotating during grounded conditions. Here, the vibrations sensor 30 senses the vibrations of the aircraft 1 and the processing unit 40 is configured to identify when the frequencies and amplitudes of those vibrations change due to the aircraft 1 operating in in-flight, transition and grounded conditions.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. A vibratory weight-on-wheels (WOW) sensing system for use with aircraft landing gear and a wheel coupled to the aircraft landing gear, the WOW sensing system comprising:
a vibration sensor disposed proximate to the wheel and configured to sense vibratory characteristics of a component of the aircraft landing gear and to issue a sensing reflective signal; and
a processing unit disposed in signal communication with the vibration sensor such that the processing unit is receptive of the sensing reflective signal,
the processing unit being configured to analyze the sensing reflective signal to thereby identify that a landing condition is in effect.

2. The WOW sensing system according to claim 1, wherein the vibration sensor is disposed on a drag beam of the aircraft landing gear.

3. The WOW sensing system according to claim 1, wherein the vibration sensor comprises an accelerometer.

4. The WOW sensing system according to claim 1, wherein the processing unit comprises a digital band pass filter.

5. The WOW sensing system according to claim 1, wherein the processing unit is configured to identify that a landing condition is in effect from changes in amplitude of the sensing reflective signal.

6. The WOW sensing system according to claim 1, wherein the processing unit is configured to generate a characteristic in-flight vibratory signature of the aircraft landing gear.

7. The WOW sensing system according to claim 1, wherein the processing unit is configured to issue a warning in an event an analysis of the sensing reflective signal gives a different indication than mechanical WOW sensors.

8. A vibratory weight-on-wheels (WOW) sensing system for use with aircraft landing gear and a wheel coupled to the aircraft landing gear, the WOW sensing system comprising:
an actuator configured to vibrate a component of the aircraft landing gear at a predefined frequency and amplitude;
a vibration sensor disposed proximate to the wheel and configured to sense vibratory characteristics of the component and to issue a sensing reflective signal; and
a processing unit disposed in signal communication with the vibration sensor such that the processing unit is receptive of the sensing reflective signal,
the processing unit being configured to analyze the sensing reflective signal to thereby identify that a landing condition is in effect.

9. The WOW sensing system according to claim 8, wherein the actuator and the vibration sensor are both disposed on a drag beam of the aircraft landing gear at a distance from each other.

10. The WOW sensing system according to claim 8, wherein the actuator and the vibration sensor are co-located on a drag beam of the aircraft landing gear.

11. The WOW sensing system according to claim 8, wherein the vibration sensor comprises an accelerometer.

12. The WOW sensing system according to claim 8, wherein the processing unit comprises a digital band pass filter.

13. The WOW sensing system according to claim 8, wherein the processing unit is configured to identify that a landing condition is in effect from changes in amplitude of the sensing reflective signal.

14. The WOW sensing system according to claim 8, wherein the processing unit is configured to generate a characteristic in-flight vibratory signature of the aircraft landing gear.

15. The WOW sensing system according to claim 8, wherein the processing unit is configured to issue a warning in an event an analysis of the sensing reflective signal gives a different indication than mechanical WOW sensors.
